(19) United States
(12) Patent Application Publication
(10) Pub. No.: US 2016/0153520 A1
(43) Pub. Date: Jun. 2, 2016

(54) METHOD AND DEVICE FOR PROTECTING DUAL MASS FLYWHEEL OF VEHICLE

(71) Applicant: HYUNDAI MOTOR COMPANY, Seoul (KR)

(72) Inventors: Jeyong YUN, Bucheon-si (KR); Junyoumg SHIN, Incheon (KR)

(21) Appl. No.: 14/741,089

(22) Filed: Jun. 16, 2015

(30) Foreign Application Priority Data
Nov. 27, 2014 (KR) 10-2014-0167639

(51) Int. Cl. F16F 15/14; F02D 41/02; F16F 15/30; F02D 41/30

(52) U.S. Cl. CPC F16F 15/14; F02D 41/3005; F02D 41/022; F16F 15/30

(57) ABSTRACT

A method for protecting a dual mass flywheel (DMF) of a vehicle includes comparing, by a controller, an RPM of a vehicle engine with a threshold value, which is set to avoid a resonance point of the DMF. If the RPM of the engine is less than the threshold value, fuel injection into the engine is shut off to stop the engine by the controller. Whether a fuel injection condition to start the engine is met is determined after the fuel injection is shut off by the controller. If the fuel injection condition is met, the fuel injection into the engine is resumed to start the engine by the controller.

### CROSS-REFERENCE TO RELATED APPLICATION

This application claims the benefit of priority to Korean Patent Application No. 10-2014-0167639 filed in the Korean Intellectual Property Office on Nov. 27, 2014, the entire content of which is incorporated herein by reference.

### TECHNICAL FIELD

The present disclosure relates to a dual mass flywheel (DMF) technology, and more particularly, to a method and device for protecting a DMF of a vehicle which enables an engine to start by applying a logic for preventing damage to the DMF.

### BACKGROUND

With a growing consumer demand for a comfortable and quiet vehicle, an active research on vibration and noise reduction is underway to improve customer satisfaction. However, a lightweight and high-powered vehicle has poor performance in reducing vehicle vibration and noise.

The vibration and noise from a vehicle drive system cause the entire vehicle to vibrate as irregular variation of torque produced from an engine is transmitted to the drive system. To reduce the vibration and noise in the drive system, a DMF system is applied to minimize the variation of the torque produced from the engine that is transmitted to the drive system.

More specifically, a flywheel is mounted between the engine and a transmission to avoid any torsional vibration from a crankshaft of the engine. Recently, application of the DMF, which has a wider damping range than a single mass flywheel, has been increased to improve damping noise, vibration, and harshness (NVH).

The dual mass flywheel can be classified into a first flywheel and a second flywheel. The first flywheel is fixed to the crankshaft, and the second flywheel is connected to the transmission via a clutch. Accordingly, when torque from the crankshaft is transmitted to the first flywheel, a damping means is subjected to tension and compression due to the relative difference in rotational speed between the first flywheel and the second flywheel, thereby causing damping torsional vibration, etc.

The dual mass flywheel may be damaged when there is a lack of gear shifting skills with manual gear cars, which may cause an abnormal noise like “click click” while the engine is idling and lead to operability problems, resulting in additional expenses incurred in replacing parts. To avoid this, a logic for preventing damage to the dual mass flywheel may be applicable.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide a method and device for protecting a dual mass flywheel (DMF) of a vehicle which enables an engine to start by applying a logic or a control system for preventing damage to the DMF.

According to an exemplary embodiment of the present inventive concept, a method for protecting a dual mass flywheel (DMF) of a vehicle method includes comparing, by a controller, a revolutions per minute (RPM) of a vehicle engine with a threshold value which is set to avoid a resonance point of the DMF. If the RPM of the engine is less than the threshold value, the fuel injection into the engine is shut off to stop the engine by the controller. Whether or not a fuel injection condition to start the engine is met is determined by the controller, after the fuel injection is shut off. If the fuel injection condition is met, the fuel injection into the engine is resumed to start the engine by the controller. If the fuel injection condition is not met, the fuel injection into the engine may be shut off.

The fuel injection is shut-off until a vehicle speed reaches 0.

The fuel injection condition may include a condition of activating a clutch signal by pressing a clutch pedal in the vehicle or a condition of a vehicle speed of 0.

According to another exemplary embodiment of the present inventive concept, a device for protecting a DMF of a vehicle includes an engine RPM detector for detecting an RPM of the vehicle engine. A fuel injection condition detector detects whether a fuel injection condition to start the engine is met or not. A controller compares the engine RPM with a threshold value which is set to avoid a resonance point of the DMF. The controller shuts off the fuel injection into the engine to stop the engine if the RPM of the engine is less than the threshold value, and resumes the fuel injection into the engine to start the engine if the fuel injection condition detector detects that the fuel injection condition is met.

If the fuel injection condition detector detects that the fuel injection condition is not met, the controller may continue the fuel injection into the engine.

The fuel injection may be shut off until a vehicle speed reaches 0.

The fuel injection condition may include a condition of activating a clutch signal by pressing a clutch pedal in the vehicle or a condition of a vehicle speed of 0.

According to the above-described embodiments of the present inventive concept, the vehicle DMF protecting method and device can start the engine by applying a logic for preventing damage to the DMF included in the vehicle.

### BRIEF DESCRIPTION OF THE DRAWINGS

In order to more fully understand the drawings used in the detailed description of the disclosure, a brief description thereof is provided.

FIG. 1 is a schematic view of a dual mass flywheel (DMF) in a normal driving condition.

FIG. 2 is a schematic of the DMF when an impact is applied.

FIG. 3 is a closed-up view of the DMF when damage occurs.

FIG. 4 is a graph showing an example of a DMF protection logic.

FIG. 5 is a graph showing an increase of impact on the DMF due to the DMF protection logic having a reset function.

FIG. 6 is a graph explaining a method for protecting a DMF for a vehicle according to an exemplary embodiment of the present inventive concept.

FIG. 7 is a flowchart showing a method for protecting a DMF for a vehicle according to an exemplary embodiment of the present inventive concept.

FIG. 8 is a block diagram of a device for protecting a DMF for a vehicle according to an exemplary embodiment of the present inventive concept.

### DETAILED DESCRIPTION OF THE EMBODIMENTS

For a better understanding of the present disclosure, and to show more clearly how it may be carried into effect, reference will now be made, by way of example, to the accompanying drawings which show exemplary embodiments of the present inventive concept.

Hereinafter, exemplary embodiments of the present inventive concept will be described in detail with reference to the accompanying drawings. In describing the embodiments of the present inventive concept, a detailed description of pertinent known constructions or functions will be omitted if it is deemed to make the gist of the present disclosure unnecessarily vague. Wherever possible, the same reference numbers will be used throughout the drawings to refer to the same or like parts.

The terms used in the specification are used to describe only specific embodiments and are not intended to limit the present disclosure. Singular forms are intended to include plural forms unless the context clearly indicates otherwise. It will be further understood that the terms “include”, “comprise” or “have” used in this specification specify the presence of stated features, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification including technical and scientific terms have the same meaning as those that are understood by persons skilled in the art. It must be understood that the terms defined by the dictionary are identical with the meanings within the context of the related art, and they should not be ideally or excessively formally defined unless the context clearly dictates otherwise.

A dual mass flywheel (DMF) has an internal spring with low stiffness. In a normal operating range, the DMF reduces variation of a torque (or speed) coming from the vehicle engine and transmits it to the transmission.

However, dynamic displacement of the internal spring becomes excessive at a resonance point of the DMF, thus exerting a large impact or impact torque to the DMF, which causes a field problem involving damage to the DMF.

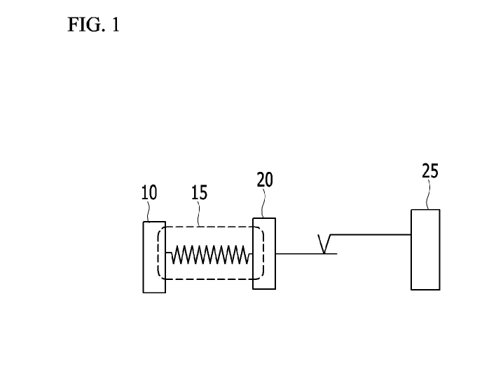

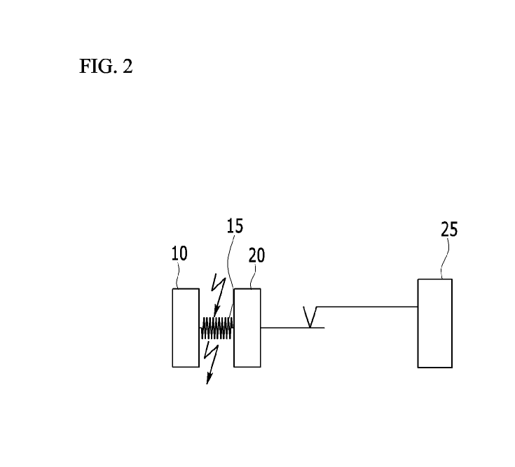

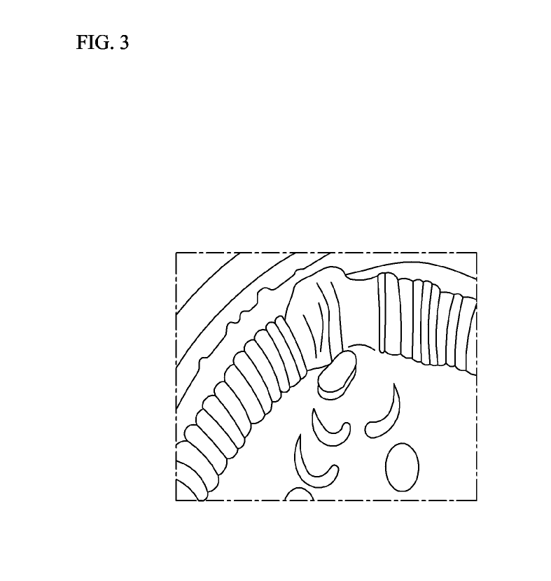

FIG. 1 is a view for explaining how a DMF works when a vehicle is in normal driving condition. FIG. 2 is a view for explaining how the DMF works when an impact occurs. FIG. 3 is an image for explaining damage to the DMF caused by an impact.

Referring to FIGS. 1 and 2, when a DMF 15 reaches a resonance point (or a resonance range) determined by its own mechanical characteristics, a spring included in the DMF 15 is completely compressed as shown in FIG. 2, and is therefore subjected to damage from impact (driving torque) between an engine 10 and a transmission 20. A drive system including drive wheels 25 may be connected to the transmission 20. The damage to the DMF caused by the driving torque (impact) is illustrated in FIG. 3.

The DMF includes two inertial masses connected to a spring having low stiffness, and the DMF in general has a unique vibrational frequency of about 13 Hz regardless. A four-cylinder engine allows the DMF to reach the resonance point at about 400 rpm (revolutions per minute), with the second order component, i.e., the main component of the combustion pressure, taken into account.

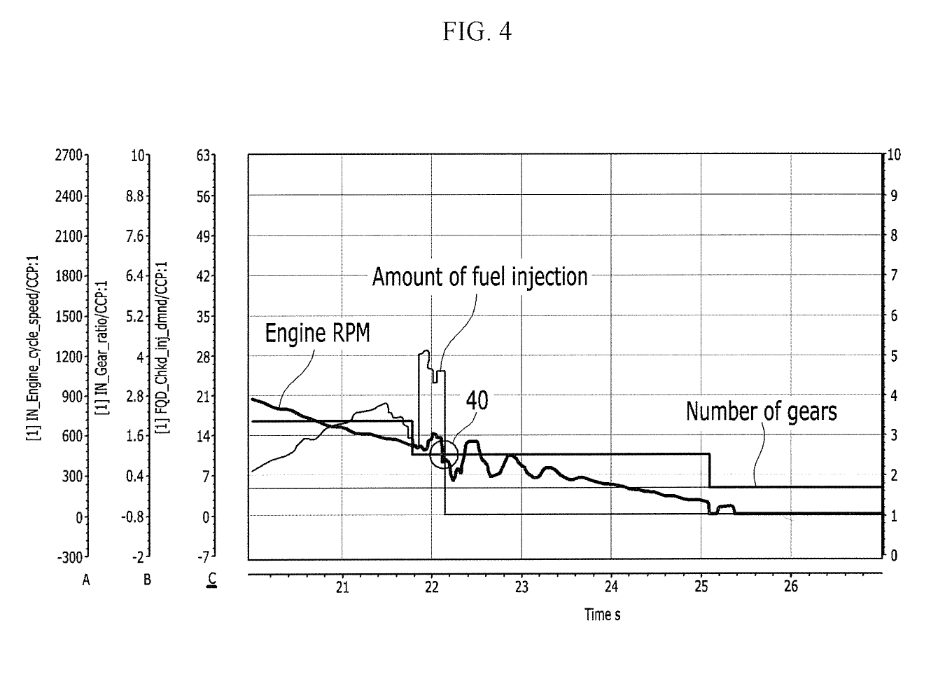

To avoid the resonance point of the DMF, a DMF protection logic to be described with reference to FIG. 4 is applied to a vehicle (or engine) with a DMF. FIG. 4 is a graph for explaining an example of a DMF protection logic.

Referring to FIG. 4, if a fuel is continuously injected into the engine even after the engine reaches 400 rpm corresponding to the resonance point of the DMF, an excessive impact may be exerted to the DMF. Accordingly, as a way to prevent impact, a protection logic is applied to the vehicle to stop the vehicle (or the engine) by shutting off the fuel injection to the engine through fuel injection control, when the engine reaches 450 rpm (40 of FIG. 4).

The aforementioned logic includes a logic for shutting off the fuel injection for 10 seconds when the engine stops. Hence, the engine does not start for 10 seconds once it stops.

To solve this problem, the DMF protection logic including a “reset” function is applied to the vehicle to start the engine by allowing for fuel injection when the RPM of the engine reaches “0” even in less than 10 seconds after the engine stops.

However, mass-production vehicles are experiencing a deterioration (increase) of the impact exerted to the DMF, caused by the reset function.

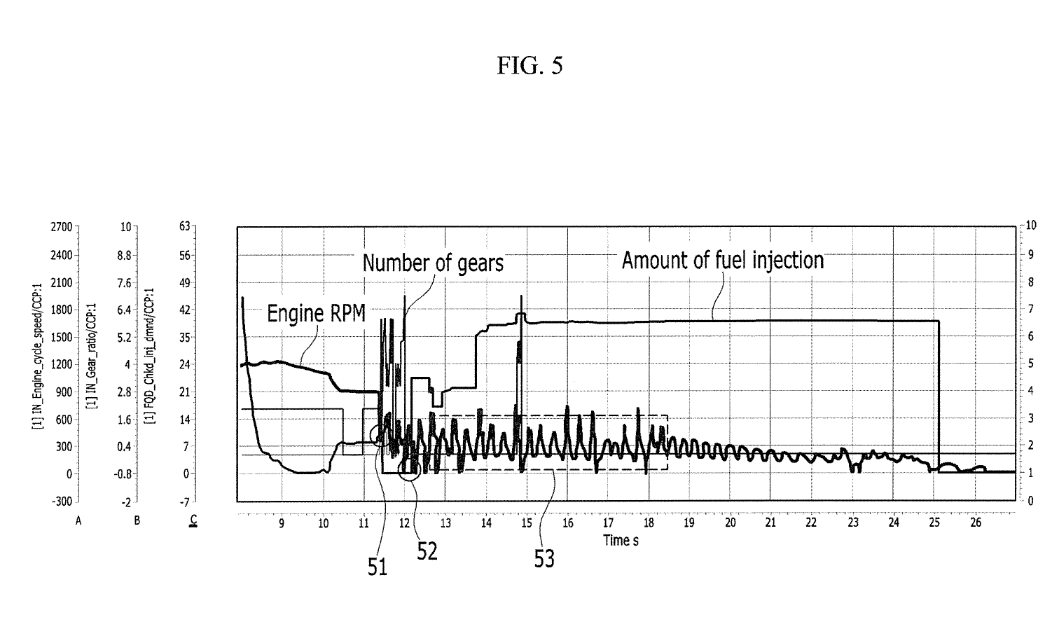

FIG. 5 is a graph for explaining an increase of the impact exerted to the DMF, caused by the DMF protection logic including a reset function.

Referring to FIG. 5, in a first period 51, when shifting to a high gear from a low gear, the RPM of the engine reaches the resonance point of the DMF depending on the selected RPM (gear ratio).

In a space between the first period 51 and a second period 52, the DMF protection logic for stopping the engine by shutting off the fuel injection is applied.

In the second period 52, even though the fuel injection is shut off, the engine RPM fluctuates wildly due to the resonance of the DMF that has already occurred, and instantly reaches “0”.

In the period subsequent to the second period 52, the fuel injection is resumed according to the DMF protection logic including the reset function, thereby starting the engine. Thus, while the engine is on, the engine may remain at the DMF resonance point for several seconds in a duration 53 of the DMF resonance. Accordingly, the DMF may be damaged due to an excessive impact exerted to the DMF.

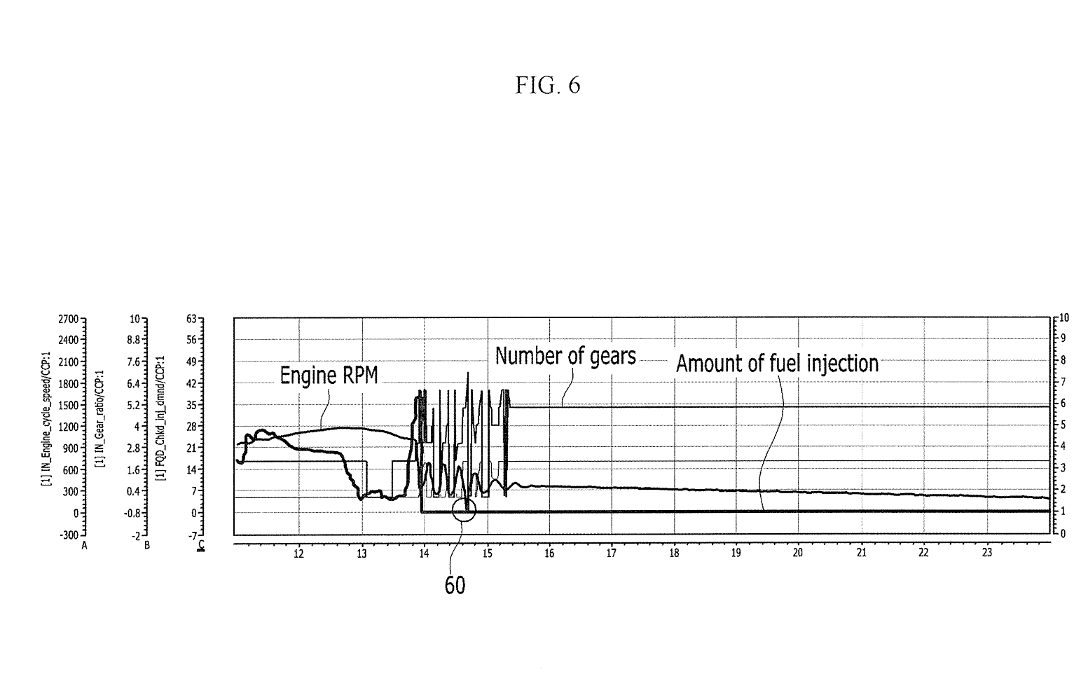

FIG. 6 is a graph for explaining a method for protecting a DMF for a vehicle according to an exemplary embodiment of the present inventive concept.

The vehicle DMF protecting method may be used to protect the DMF by applying a logic for eliminating the reset function from the DMF protection logic including the reset function for resuming fuel injection when the aforementioned engine RPM reaches “0”, and to overcome the fact that the engine cannot for 10 seconds if the reset function is eliminated.

Referring to FIG. 6, in the present disclosure, the engine may stop without a resonance of the DMF, because the fuel is not injected into the engine even when the engine RPM reaches the zero point 60. As a result, damage to the DMF mounted between the vehicle engine and the transmission may be prevented. The DMF may have a similar structure to the DMF explained with reference to FIGS. 1 and 2.

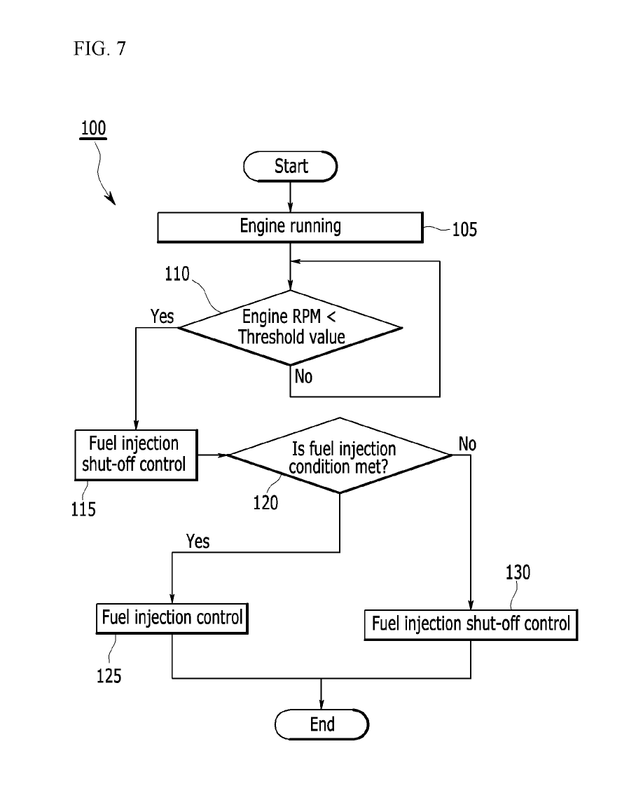

FIG. 7 is a flowchart showing a method for protecting a DMF for a vehicle according to an exemplary embodiment of the present invention.

The vehicle DMF protecting method may be a logic (control logic) for protecting the DMF from an impact exerted to the DMF of the vehicle.

Referring to FIG. 7, in the running step 105, the vehicle engine may run at a specific rotational speed (rpm).

In the comparison step 110, the revolutions per minute (RPM) of the vehicle engine may be compared with a threshold value to avoid a resonance point of the DMF to determine whether the RPM of the engine is less than the threshold value or not. The threshold value may be, for example 450 rpm, and may be determined by a test.

If the RPM of the engine is not less than the threshold value, a process corresponding to the vehicle DMF protecting method 100 proceeds to the comparison step 110. On the contrary, if the RPM of the engine is less than the threshold value, the process may proceed to the fuel injection shut-off control step 115.

In the fuel injection shut-off control step 115, if the RPM of the engine is less than the threshold value, the fuel injection into the engine may be shut off to stop the engine. As a result, the engine may stop, and therefore, no resonance occurs in the dual mass flywheel, thus preventing damage to the DMF.

In the condition assessment step 120, whether a fuel injection condition for determining whether to start the engine is met or not may be assessed after the fuel injection shut-off control. The fuel injection condition may include a condition of activating a clutch signal by pressing a clutch pedal in the vehicle or a condition of a vehicle speed of 0.

More specifically, in the condition assessment step 120, a condition for resuming the fuel injection depending on whether the driver or user has the intention of starting the engine may be provided under the condition that the fuel injection is stopped as the engine is shut off.

The condition provided may include activating a clutch signal. That is, when the driver presses the clutch pedal, it is determined that the driver has the intention of starting the engine. The condition provided may include a vehicle speed. That is, if the vehicle speed, rather than the engine's RPM, is “0”, the fuel injection may be resumed anytime.

In the fuel injection control step 125, if the fuel injection condition is met, the fuel may be injected into the engine to start the engine.

More specifically, in the fuel injection control step 125 may be a step of waiting for the shut-off condition to be released and for the fuel injection condition to be met, so that the fuel injection is resumed anytime if the driver gives a signal to run the vehicle in the condition assessment step 120.

In the fuel injection shut-off control step 130, as long as the fuel injection condition is not met, the fuel injection into the engine continues to be shut off. As a result, the engine may not start.

More specifically, in the fuel injection shut-off control step 130, if it is determined that the driver has no intention of starting the engine in the condition assessment step 120, the fuel injection into the engine may not be executed even when the accelerator pedal is pressed. This is because, if the driver presses the accelerator pedal without starting the engine, while the engine (internal combustion engine) is in the shut-off state, the engine immediately reaches a resonance RPM band of the DMF, thus causing damage to the DMF.

The duration of fuel injection shut-off (the duration of fuel injection shut-off control) is long enough to bring the vehicle speed to “0”, for example, 10 seconds. That is, the duration of fuel injection shut-off may indicate a period of time until the vehicle speed reaches 0 (or close to 0) after the fuel injection into the engine is shut off.

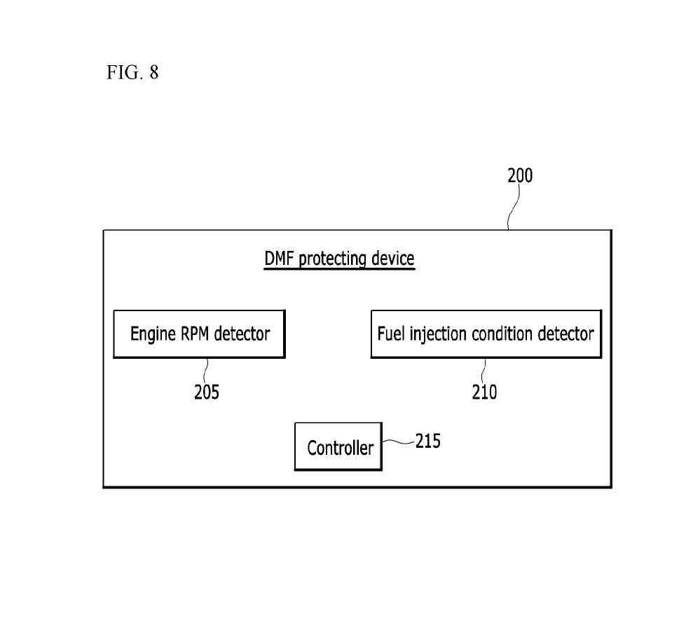

FIG. 8 is a block diagram for explaining a device for protecting a DMF for a vehicle according to an exemplary embodiment of the present inventive concept.

Referring to FIG. 8, a vehicle DMF protecting device 200 may include an engine RPM detector 205, a fuel injection condition detector 210, and a controller 215.

The engine RPM detector 205 may detect RPM, which is the rotational speed of the vehicle engine.

The fuel injection condition detector 210 may detect whether a fuel injection condition for determining whether to start the engine is met or not.

The controller 215 compares the engine's RPM detected by the engine RPM detector 205 with a threshold value set to avoid a resonance point of the DMF. If the RPM of the engine is less than the threshold value, the controller 215 may shut off the fuel injection into the engine to stop the engine. On the other hand, if the fuel injection condition detector 210 detects that the fuel injection condition is met, the controller 215 may resume the fuel injection into the engine to start the engine. The threshold value may be determined by a test.

If the fuel injection condition detector 210 detects that the fuel injection condition is not met, the controller 215 may keep the fuel injection into the engine shut off. The duration of fuel injection shut-off may indicate a period of time until the vehicle speed reaches 0.

The fuel injection condition may include activating a clutch signal by pressing a clutch pedal in the vehicle or a vehicle speed of 0.

The controller 215 may perform functions of a central processing unit (CPU (or processor, and control the overall operations of the engine RPM detector 205 and fuel injection condition detector 210. The controller 215 may include a program including a series of commands for performing the vehicle DMF protecting method 100 of this disclosure.

The components, units, blocks, or modules used in the exemplary embodiment may be implemented by software components, such as tasks, classes, subroutines, processes, objects, execution threads, or programs, or by hardware components, such as an field programmable gate array (FPGA) or application specific integrated circuit (ASIC), or by combinations of the software and hardware components. The components may be included in a computer-readable storage medium, or some of the components may be distributed in a plurality of computers.

As described above, the optimum embodiments have been disclosed in the drawings and the specification. Although the specific terms have been used herein, they have been used merely for the purpose of describing the present disclosure, and have not been used to limit the meanings thereof and the scope of the present disclosure set forth in the claims. Therefore, it will be understood by those having ordinary knowledge in the art that various modifications and other equivalent embodiments can be made. Accordingly, the true technical protection range of this disclosure should be defined by the technical spirit of the attached claims.

What is claimed is:

1. A method for protecting a dual mass flywheel (DMF) of a vehicle, the method comprising steps of:
comparing, by a controller, a revolutions per minute (RPM) of a vehicle engine with a threshold value, which is set to avoid a resonance point of the DMF;
shutting off, by the controller, fuel injection into the engine to stop the engine if the RPM of the engine is less than the threshold value;
determining, by the controller, whether or not a fuel injection condition for starting the engine is met after the step of shutting off; and
resuming, by the controller, the fuel injection into the engine to start the engine if the fuel injection condition is met.

2. The method of claim 1, wherein, if the fuel injection condition is not met at the step of determining, the fuel injection into the engine is shut off.

3. The method of claim 2, wherein the fuel injection is shut-off until a vehicle speed reaches 0.

4. The method of claim 1, wherein the fuel injection condition includes a condition of activating a clutch signal by pressing a clutch pedal in the vehicle or a condition of a vehicle speed of 0.

5. A device for protecting a DMF of a vehicle, the device comprising:
an engine RPM detector configured to detect an RPM of a vehicle engine;
a fuel injection condition detector configured to detect whether or not a fuel injection condition for starting the engine is met; and
a controller configured to compare the engine RPM with a threshold value which is set to avoid a resonance point of the DMF,
wherein the controller shuts off fuel injection into the engine to stop the engine if when the engine RPM is less than the threshold value, and resumes the fuel injection into the engine when the fuel injection condition is met.

6. The device of claim 5, wherein the controller continues the fuel injection into the engine when the fuel injection condition detector detects that the fuel injection condition is not met.

7. The device of claim 6, wherein the fuel injection is shut-off until a vehicle speed reaches 0.

8. The device of claim 5, wherein the fuel injection condition includes a condition of activating a clutch signal by pressing a clutch pedal in the vehicle or a condition of a vehicle speed of 0.
